(19) United States
(12) Patent Application Publication
(10) Pub. No.: US 2006/0250785 A1
(43) Pub. Date: Nov. 9, 2006

(54) Logo illuminating device

(76) Inventors: Mario Cugini, Vista, CA (US); Ralph Giusti, Vista, CA (US); Clement Serafin, Vista, CA (US)

Correspondence Address: LAW OFFICES OF CALIF KIP TERVO, 6387 CAMINITO LAZARO, SAN DIEGO, CA, 92111, US

(21) Appl. No.: 11/123,447

(22) Filed: May 6, 2005

(51) Int. Cl. F21V 33/00

(52) U.S. Cl. 362/103; 362/155; 362/156

(57) ABSTRACT

The combination if a useful article, such as a purse, pack, clothing, or footwear, and a logo illuminating device including a housing attached to the article including a logo and a circuit including a battery, a logo illuminating light source for back illuminating the logo and a switch unit including a switch having an on position activating the logo illuminating means with energy from the energy source responsive to use of the article. In one embodiment, the useful article includes a compartment; and access means for selectively creating an opening for accessing the compartment, and the logo is visible externally the compartment, and the switch is activated by accessing the compartment. The user may turn off the device.

### FIELD OF THE INVENTION

This invention relates in general to an illuminating device and more specifically to an illuminating device for the logo of a product.

### BACKGROUND OF THE INVENTION

Brand recognition is very important in a highly competitive market place. Logos including brand names are being displayed more and more prominently on goods as a method of brand recognition, promoting brand loyalty, and advertising.

It would be desirable to have an additional method of calling attention to the brand.

### BRIEF DESCRIPTION OF THE DRAWINGS

FIG. 1 is a perspective view of a preferred embodiment of the illuminating device of the invention attached to a purse.

FIG. 2 is a partial enlarged cross section of the purse of FIG. 1 showing the attached illuminating device in side elevation view with the purse closed.

FIG. 3 is a partial enlarged front elevation view of the illuminating device and purse of FIG. 2.

FIG. 4 is an enlarged side elevation exploded view, partially in cross section, of the illuminating device of FIG. 2.

FIG. 5 is a rear perspective view of the illuminating device of FIG. 2.

FIG. 6 is a front, top perspective view of an alternate embodiment of the logo illuminating device attached to a shoe.

### DETAILED DESCRIPTION OF THE INVENTION

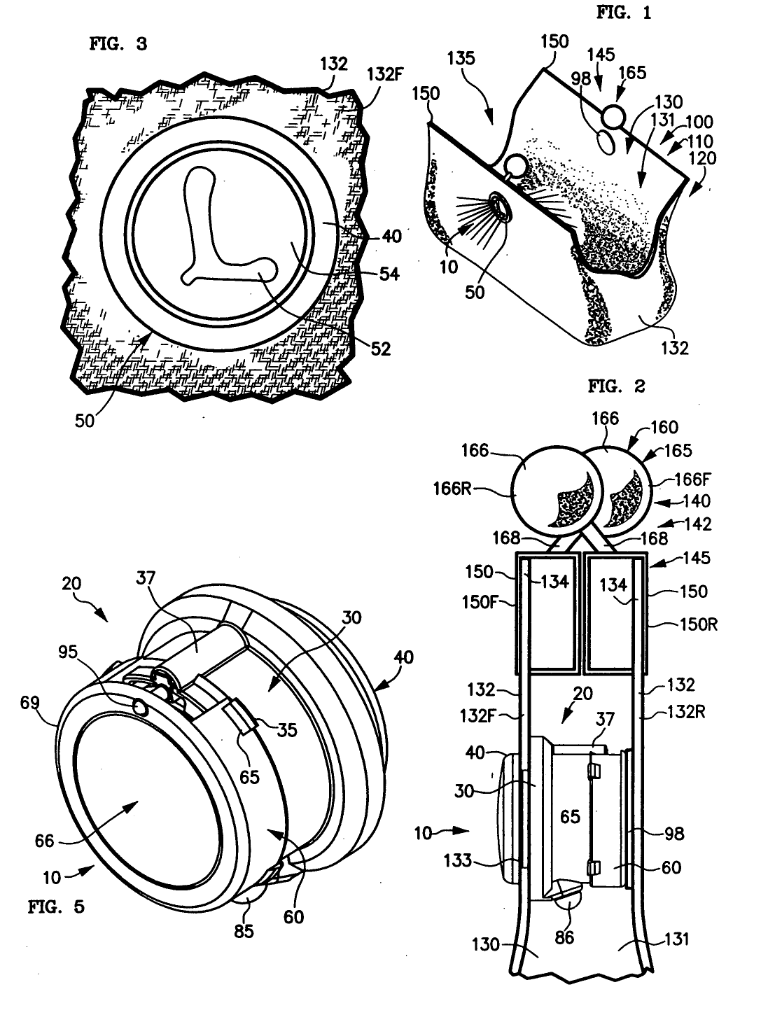

With reference now to the drawings, and more particularly to FIGS. 1-3 thereof, there is shown in FIG. 1 a perspective view of a preferred embodiment of the illuminating device 10 including an illuminated logo 50 of the invention attached to a useful article 100, such as container 110, such as a purse 120, in FIG. 2 a partial enlarged cross section of the purse of FIG. 1 showing the attached illuminating device 10 in side elevation view with purse 120 closed, and in FIG. 3 a partial enlarged front elevation view of illuminating device 10 and purse 120 of FIG. 1.

Although a particular embodiment of the invention is being illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

Purse 120 includes a useful feature 130, such as a compartment 131 for holding articles defined by walls 132, including a front wall 132F and a rear wall 132R, and activation means 140, such as access means 142, such as closure 145, for using compartment 131 by selectively providing an opening 135 for access thereto. Walls 132 may be made of any suitable material, such as cloth, such as is well known in the art. Closure 145 may be of many suitable closure designs, however closure 145 shown is a snap type comprising a pair of stiffeners 150 including front stiffener 150F and rear stiffener 150R, to which the tops 134 of front wall 132F and rear wall 132R respectively are attached. Latching means 160, such as cooperating latching means, such as hook/loop fastener, or snap 165, are movable by the user between a latched position holding stiffeners 150 in proximity to one another such that opening 135 is closed and an unlatched position wherein stiffeners 150 are not so held such that they may be separated to form opening 135. Snap 165 shown is of a well known type including balls 166, including front and rear balls 166F, 166R, each mounted on a resilient stem 168 on front and rear stiffeners 150F, 150R, respectively. Balls 166 interfere with one another and act as a detent to hold stiffeners 150 in the closed position.

Illuminating device 10 includes a housing 20 mounted on purse 120, such as on front wall 132F. Housing 20 generally includes main body 30, front cover 40, logo 50 and rear cover 60. Logo 50 includes a logo symbol 52 and logo area 54 around logo symbol 52.

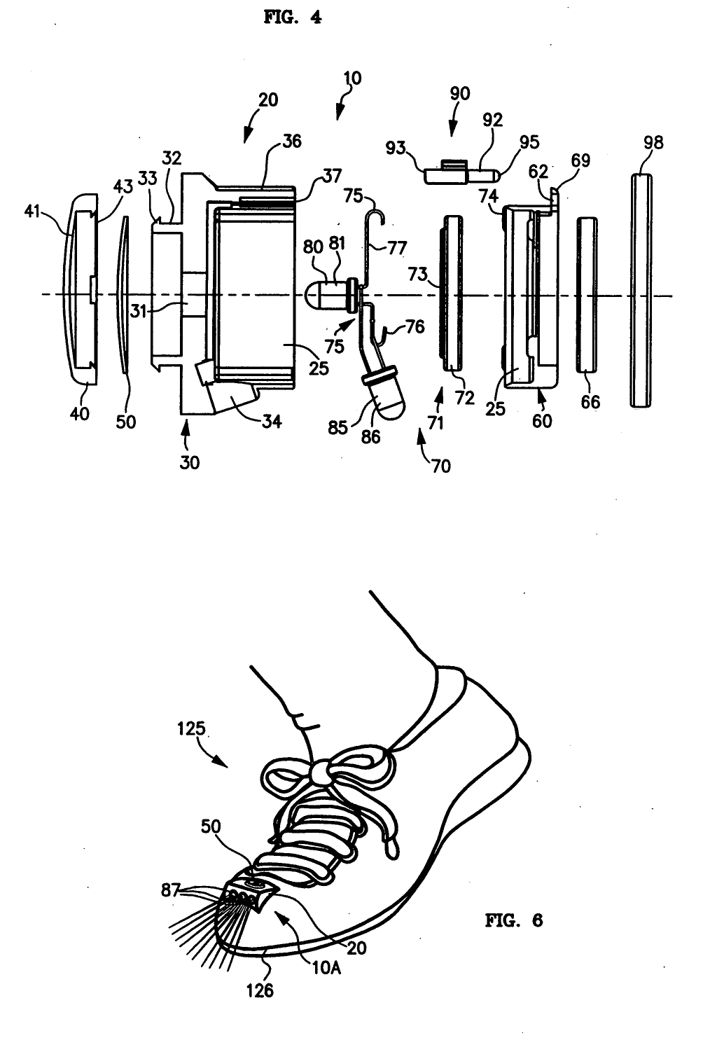

Further including FIGS. 4 and 5, FIG. 4 is an enlarged side elevation exploded view, partially in cross section, of illuminating device 10 of FIG. 2, and FIG. 5 is a rear perspective view of the illuminating device 10 of FIG. 2. Housing 20 is of generally cylindrical configuration. Housing 20 includes a portion of smaller circumference, such as hollow neck 32 on main body 30 for disposition in bore 133 in front wall 132F of purse 120 for attaching device 10 to purse 120. Neck 32 and front cover 40 include cooperating attachment means, such as circumferential flange 33 on neck 32 and inward circular flange 43 on front cover 40 by which front cover 40 can be selectively attached to neck 32 by clicking it on and off. Front cover 40 is of larger circumference than neck 32 so as to retain neck 32 in mounting bore 133 in purse 120. Logo 50 is held to neck 32 by front cover 40. Logo 50 may be of any suitable material, such as plastic or a film sheet. The logo symbol 52 and the logo area 54 are contrasting and either may be applied to logo 50 in any desirable manner, such as painting or etching. Logo 50 may be transparent. Front cover 40 is optically transparent to allow viewing of logo 50. Alternately, logo 50 may be integral with front cover 40 and may even be attached, such as by screening, to front surface 41 of front cover 40. Alternately, also, front cover 40 may be integral with housing 20 so as to be water proof.

Attaching means, such as cooperating detent barbs 35, 65 on main body 30 and rear cover 60, respectively, selectively attach rear cover 60 to main body 30.

Illuminating circuit 70 is disposed in central cavity 25 in housing 20. Circuit 70 includes an electrical energy source 71, such as coin cell type battery 72; logo illuminating means 80, such as a light source, such as first light emitting diode, such as logo illuminating LED 81, additional illuminating means 85, such as second light emitting diode, such as compartment illuminating LED 86, connectors 75 including spring contacts 76, 77 for connecting LEDS 81,86 to battery 72, and switch means 90, such as push button 92, having an activated position wherein battery 72 is connected to diodes 81, 86 such that LEDS 81, 86 are lit and a deactivated position wherein battery 72 is disconnected from LEDS 81,86 such that LEDS 81,86 are off. Although LEDS 81, 86 are shown and described, other illuminating means, such as incandescent lights or electroluminescent lights, may be used.

Logo illuminating LED 81 is mounted in front socket 31 in main body 30 so as to backlight logo 50 through hollow neck 32. Second LED 86 is mounted in bottom socket 34 so as to shine downward and illuminate compartment 131 of purse 120. Selective removal of front cover 40 and logo 50 permits LED 81 to function as a flash light external to article 100. Although only one light source each is shown for illuminating logo 50 and compartment 131, with small alteration, multiple light sources could be used for each function.

Spring contact 76 connects first leads 88 of LEDS 81, 86 to center pole 73 of battery 72. Spring contact 77 connects second leads 89 of LEDS 81, 86 to outer pole 74 of battery 72. Push button 92 is slidingly disposed in a longitudinal bore 37 in a radial projection 36 of main body 30. Front end 93 of push button 92 contacts spring contact 77 such that push button 92 is resiliently biased rearward thereby. With switch 90 in the “on” position, spring contact 77 is in contact with outer post 74 of battery 72 and rear end 95 of push button 92 is disposed through bore 62 in rear cover 60 so as to extend rearward slightly past the rear 69 of rear cover 60. Moving push button 92 forward from this position pushes spring contact 77 away from contact with outer post 74 of battery 72 and opens the circuit to turn LEDS off.

Push button 92 may be activated in any desired manner. The embodiment shown uses magnetic means to activate switch 90. A ferrous or magnetic plate 66 is attached to rear 69 of rear cover 60 by any suitable means, such as by riveting or gluing. A cooperating magnetically attracting ferrous or magnetic plate 98 is attached by suitable means, such as adhesive or sewing about its border, to rear wall 132R of compartment 131, as seen in FIGS. 1 and 2. When walls 132F, 132R are in proximity, plate 98 attaches to plate 66 such that push button 92 is pushed forward, opening circuit 70. When compartment 131 is accessed, such as by opening closure 145, plates 66, 98 are separated, push button 92 is moved rearward by spring contact 77 and spring contact 77 contacts battery 72 to close circuit 70 and light LEDS 81, 86.

The user may selectively open circuit 70 by pushing forward on rear end 95 of push button 92 and may selectively keep it in the open position by then slightly rotating rear cover 60 such that push button 92 is not aligned with bore 62 and cannot move rearward to the closed position. In this manner, the user can turn off device 10.

Although a switch 90 of the push button type is shown, other switches may be used. A rocker switch may be used, for example, for activation by a zipper slider.

FIG. 6 is a front, top perspective view of an alternate embodiment of the logo illuminating device 10A attached to footwear, such as to shoe 125. Logo illuminating device 10A includes a housing 20 attached by any suitable means, such as gluing or adhesive to shoe 125, such as to front 126 of shoe 125. Alternate device 10A is similar to device 10 in that it includes circuitry for illuminating logo 50 and additional illuminating means 85, such as lights, such as a plurality of bright LEDS 87 shining forward to light the way for the wearer. A motion switch, such as is well known in the art, may be used to activate the circuit such that device 10A illuminates logo and path when shoe 125 is in movement.

Having described the invention, it can be seen that it provides a very convenient device for calling attention to the brand of the purse, luggage, backpack or other goods, such as clothing, such as jackets having pockets, and additionally provides for useful light for taking advantage of a feature, such as a compartment, of the goods. Marketing value is achieved by the change of state perception by human eyes as the logo is illuminated. Activation is caused by a willful effort to implement a feature, such as opening a pocket, purse, or backpack, operating a zipper, or stepping on a shoe. This energizes a light which indicates the feature is in use to the people in the surrounding vicinity. The on/off feature catches the attention of people much more than any constantly illuminated sign.

Although a particular embodiment of the invention has been illustrated and described, various changes may be made in the form, composition, construction, and arrangement of the parts herein without sacrificing any of its advantages. For example, the circuit may include timing circuitry as is well known in the art to delay turning the circuit on or, particularly, off. Other circuit components may include an intermittent function in the logo light such that it blinks. The light or lights may be of any suitable type and the switch may be mechanical, optical, magnetic or other types well known in the art. Therefore, it is to be understood that all matter herein is to be interpreted as illustrative and not in any limiting sense, and it is intended to cover in the appended claims such modifications as come within the true spirit and scope of the invention.

I claim:

1. In combination:
a useful article; and
a logo illuminating device including:
a housing attached to said article including
a logo;
a circuit attached to said housing including:
an electrical energy source,
a first illuminating means having an activated condition for back illuminating said logo and having a deactivated condition; and
a switch unit including:
a switch having an on position activating said logo illuminating means with energy from said energy source responsive to use of the article.

2. The combination of claim 1 wherein:
said housing includes:
a selectively detachable front cover retaining said logo.

3. The combination of claim 1 wherein:
said logo illuminating device includes:
user selective means for turning off said device.

4. The combination of claim 1 wherein:
said logo illuminating device further includes:
a second illuminating means having an activated condition for illuminating the surroundings of said housing and having a deactivated condition; and wherein
said switch has an on position activating said second illuminating means with energy from said energy source responsive to use of the article.

5. The combination of claim 4 wherein:
said useful article is footwear having a front and a rear;
said switch is in the on position responsive to said footwear being used for walking; and
said second illuminating means illuminates in front of said footwear.

6. The combination of claim 1 wherein:
said useful article includes:
a compartment; and
access means for selectively creating an opening for accessing said compartment or closing an access opening to said compartment; and
said housing is attached to said compartment such that said logo is visible externally said compartment; and
said switch has an on position activating said logo illuminating means with energy from said energy source responsive to said access means creating an opening for accessing said compartment and an off position de-activating said logo illuminating means responsive to said access means closing an access opening to said compartment.

7. The combination of claim 6 wherein:
said logo illuminating device further includes:
a compartment illuminating means having an activated condition for illuminating said compartment and having a deactivated condition, and wherein
said switch has an on position activating said compartment illuminating means with energy from said energy source responsive to said access means creating an opening for accessing said compartment and an off position de-activating said compartment illuminating means responsive to said access means closing an access opening to said compartment

8. In combination:
a useful article including:
a useful feature; and
activation means having movement in a first direction during use of said useful feature; and
a logo illuminating device including:
a housing attached to said article including
a logo;
a circuit attached to said housing including:
an electrical energy source,
a logo illuminating means having an activated condition for back illuminating said logo and having a deactivated condition; and
a switch unit including:
a switch having an on position activating said logo illuminating means with energy from said energy source responsive to movement of the activation means in the first direction.

9. The combination of 8 wherein:
said switch has an off position de-activating said logo illuminating means responsive to said movement of said activation means in the second direction.

10. The combination of claim 8 wherein:
said activation means is a zipper.

11. The combination of 8 wherein:
said logo illuminating device further includes:
a second illuminating means having an activated condition for illuminating the surroundings of said housing and having a deactivated condition; and wherein
said switch has an on position activating said second illuminating means with energy from said energy source responsive to movement of the activation means in the first direction.

12. In combination:
a useful article including:
a compartment; and
access means for selectively creating an opening for accessing said compartment or closing an access opening to said compartment; and
an illuminating device including:
a housing attached to said compartment including:
a logo visible externally said compartment; and
a circuit attached to said housing including:
an electrical energy source,
a logo illuminating means having an activated condition for back illuminating said logo and having a deactivated condition; and
a switch unit including:
a switch having an on position activating said logo illuminating means with energy from said energy source responsive to said access means creating an opening for accessing said compartment and an off position de-activating said logo illuminating means responsive to said access means closing an access opening to said compartment.

13. The combination of claim 12 wherein:
said useful article is an article of clothing; and
said compartment is a pocket.

14. The combination of claim 12 wherein:
said housing includes:
a selectively detachable front cover retaining said logo; whereby, when said front cover is detached, said logo illuminating means provides viewing illumination external of said compartment.

15. The combination of claim 12 wherein:
said logo illuminating device includes:
user selective means for turning off said device.

16. The combination of claim 12 wherein:
said compartment includes:
a first wall; and
a second wall; and wherein
said switch unit includes:
first cooperative magnetic means attached to said first wall; and
second cooperative magnetic means attached to said second wall.

17. The combination of claim 12 wherein:
said illuminating device further includes:
a compartment illuminating means having an activated condition for illuminating said compartment and having a deactivated condition, and wherein
said switch has an on position activating said compartment illuminating means with energy from said energy source responsive to said access means creating an opening for accessing said compartment and an off position de-activating said compartment illuminating means responsive to said access means closing an access opening to said compartment.

18. The combination of claim 17 wherein:
said useful article is an article of clothing; and
said compartment is a pocket.

19. The combination of claim 12 wherein:
said housing includes:
a selectively detachable front cover retaining said logo; whereby, when said front cover is detached, said logo illuminating means provides viewing illumination external of said compartment.

20. The combination of claim 12 wherein:
said logo illuminating device includes:
user selective means for turning off said device.
